(19) United States
(12) Patent Application Publication
(10) Pub. No.: US 2024/0262762 A1
(43) Pub. Date: Aug. 8, 2024

(54) SYSTEM AND METHOD OF COMPOSTING HUMAN REMAINS

(71) Applicant: Alkaline Hydrolysis of Colorado LLC, Boulder, CO (US)

(72) Inventors: Seth Viddal, Longmont, CO (US); Chris Olachia, Aurora, CO (US)

(21) Appl. No.: 18/106,229

(22) Filed: Feb. 6, 2023

(51) Int. Cl. C05F 17/10; B09B 3/60; C05F 1/02; C05F 17/20; C05F 17/979

(52) U.S. Cl. CPC C05F 17/10; B09B 3/60; C05F 1/02; C05F 17/20; C05F 17/979

(57) ABSTRACT

A method of composting human remains to produce a composting material. Human remains are placed into a vessel. A bulking agent mixture can be placed with the human remains in the vessel. The method also includes placing a compost solution in the vessel to accelerate the composting of the human remains. A system used in the process for composting human remains includes a vessel for receiving the human remains, a bulking agent mixture, and a compost solution. The system includes at least one opening in a lower part of the vessel for receiving a stream of air. The system also includes a lid for closing the human remains, the bulking agent mixture, and the compost solution in the vessel. Further, the system includes an outlet disposed in the vessel to permit the air from the at least one opening and unpleasant odors created in the vessel to be withdrawn from the vessel.

### STATEMENT REGARDING FEDERALLY SPONSORED RESEARCH OR DEVELOPMENT

Not applicable.

### CROSS-REFERENCE TO RELATED APPLICATIONS

Not applicable.

### BACKGROUND OF THE DISCLOSURE

### 1. Field of the Invention

The present disclosure relates to a method for composting human remains and a composting system for facilitating the composting process.

### 2. Description of the Related Art

Typically, when a person dies burial and cremation are the primary methods of handling the human remains. Composting human remains is a less common method of handling human remains. There are various issues with composting in the current practices of it.

Accordingly, there is a need for a composting process for human remains that addresses some of these various issues.

### SUMMARY OF THE DISCLOSURE

The present disclosure is directed to a method of composting human remains to produce a composting material. Human remains are placed into a vessel. A bulking agent mixture can be placed with the human remains in the vessel. The method also includes placing a compost solution in the vessel to accelerate the composting of the human remains.

The present disclosure is directed to a system used in a process for composting human remains. The system includes a vessel for receiving the human remains, a bulking agent mixture, and a compost solution. The system includes at least one opening in a lower part of the vessel for receiving a stream of air. The system also includes a lid for closing the human remains, the bulking agent mixture, and the compost solution in the vessel. Further, the system includes an outlet disposed in the vessel to permit the air from the at least one opening and unpleasant odors created in the vessel to be withdrawn from the vessel.

### BRIEF DESCRIPTION OF THE DRAWINGS

FIG. 1 is a perspective view of a composting system constructed in accordance with the present disclosure.

FIG. 2 is cross-sectional view of a part of an apparatus that is part of the composting system depicted in accordance with the present disclosure.

FIG. 3 is a perspective view of another embodiment of the composting system constructed in accordance with the present disclosure.

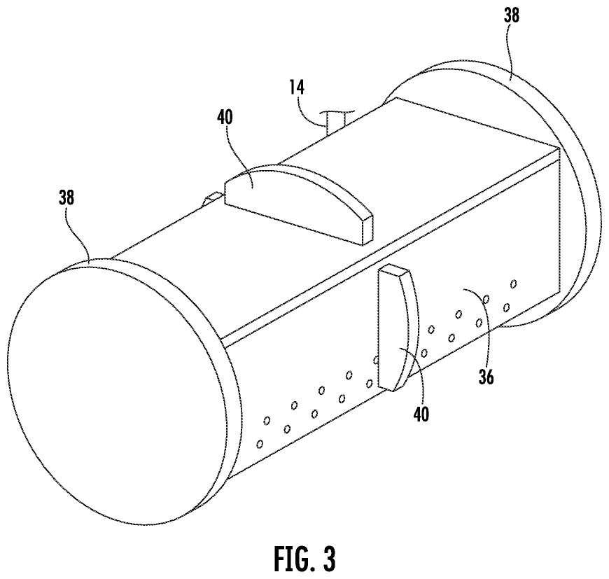

### DETAILED DESCRIPTION OF THE DISCLOSURE

The present disclosure is directed to a composting system and composting process for human remains (typically a deceased body) to generate a compost. The composting process generally includes providing human remains 10 to a vessel 12 and mixing the human remains 10 with a bulking agent mixture 14 to decompose the human remains 10 into a regenerative soil. A bio-active blend of bacteria and fungi are used to make a compost solution that can be added to the bulking agent mixture 14 and/or the human remains 10 to inoculate and promote the composting process.

The bulking agent mixture 14 can include any type of bulking agents known in the art to promote composting of the human remains 10. The bulking agents can include, but are not limited to, straw, wood chips, hay, corn cobs, alfalfa, spent hops (which are a by-product of beer brewing), earthworm castings, and any other vegetative material. The total amount of bulking agent included in the bulking agent mixture is dependent upon the amount of human remains 10 to be composted. In one exemplary embodiment of a 100-pound body, the bulking agent mixture 14 can include straw in a range of from about 30-50 lbs, 50-70 lbs of wood chips, 20-40 lbs of corn cobs and/or spent hops and 20-40 lbs of earthworm castings. Care is taken to ensure that the body is completely covered by the bulking agents.

A compost solution is brewed by allowing some of the bio-active blend to aerate in oxygenated water for 48 hours. About 4 gallons of compost solution is poured over the body and bulking agents. This compost solution is a rich mixture 14 of biologically active fungi and bacteria. The compost solution can be added to the vessel with the human remains and the bulking agent mixture any number of times to accelerate the composting process.

After the bulking agent mixture, the human remains and the compost solution are placed in the vessel 12, the vessel 12 is sealed to permit the composting process to occur. The vessel 12 can include a temperature sensor and a moisture meter to monitor the temperature and moisture in the vessel 12. The temperature to be monitored is the temperature at the core of the vessel 12.

The composting process naturally generates heat. This heating is beneficial because if it is allowed to rise above a specified threshold and held above that temperature for a specified length of time, then this is considered sufficient to kill any pathogens that may have been introduced by the human remains. Public health laws dictate the minimum temperature and duration in order the process to be deemed safe.

In one embodiment, the temperature is permitted to raise above 131 degrees Fahrenheit for more than 72 hours to kill any pathogens present. The contents of the vessel 12 can then be stirred, mixed, turned over, etc., which allows aerobic composting to resume and temporarily reduces the temperature of the contents of the vessel. This process step (shutting in, letting the heat increase to a certain temperature for a certain amount of time and stirring), which can take numerous weeks and even months, can be repeated multiple times to allow the soft tissue of the body to be fully composted. In one embodiment, the compost process can include at least three process steps. In another embodiment, the compost process is carried out for longer than 90 days. In another embodiment, some species of bacteria and fungi are used primarily in the reduction of soft tissue in the body, and others are introduced later in the process for the further decomposition of bone.

After the primary composting has satisfied the standards required for the composting material to be considered safe to handle, the contents of the vessel 12 can be filtered to remove inorganic materials, such as items placed in a body during surgery. The bones that are present can be removed if desired and ground up, pulverized or reduced using conventional funerary methods.

At some point in the body composting process, bones can be exposed and a biochar mixture can be provided to the vessel that is more tailored to decomposition of bones. For example, this biochar mixture can include other strains of bacteria that can rapidly digest bones.

After the primary composting has been completed in the sealed vessel, the soil is removed and placed into a bin. The bin is exposed to the air and allowed to cure (where curing is a short aging process that dries the soil and slows or stops some biological processes). This curing process gives the compost time to out-gas and develop into mature compost that has the optimal carbon-to-nitrogen ratio which is most beneficial as agricultural soil. This curing phase can take several weeks. Tests can be done to determine its degree of maturity. Likewise, the soil can be examined under the microscope to see its biological vitality.

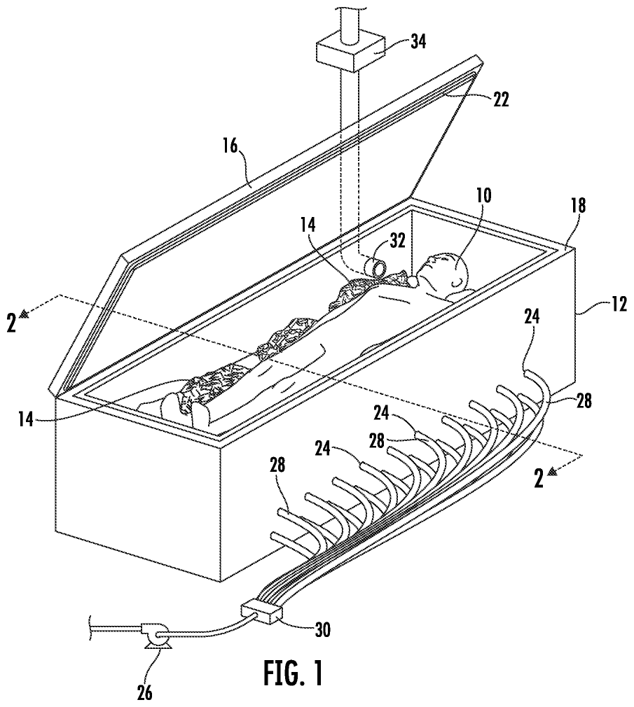

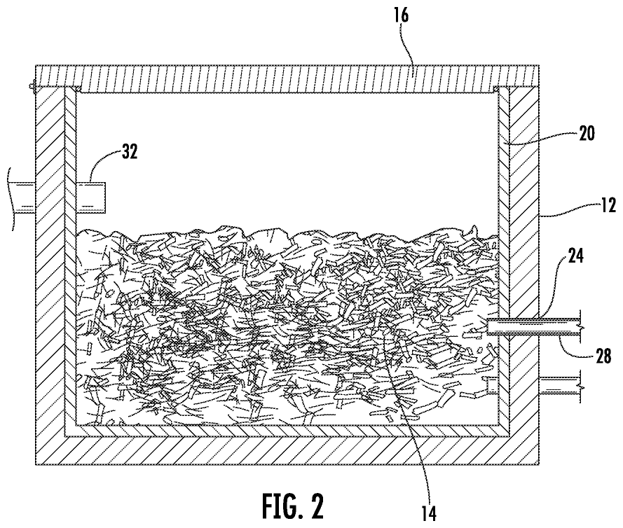

Referring now to FIGS. 1 and 2, shown therein is the vessel 12 with a lid 16 and a primary compartment 18. The lid 16 can be attached by a hinge to the primary compartment 18 if desired. The lid 16 and the primary compartment 18 can include an impervious membrane 20 to insulate and seal the vessel 12. The vessel 12 can also include a gasket 22 between the lid 16 and the primary compartment 18 to bridge the insulation and sealing of the lid 16 and the primary compartment 18 by the impervious membrane. The gasket 22 can be attached to the lid 16 or the primary compartment 18.

Our composting technique is an aerobic process. In order to provide oxygen, the primary compartment 18 can include at least one opening 24 therein in a lower portion thereof to permit air to be pumped into the vessel 12. In one embodiment, the primary compartment 18 includes multiple openings 24 disposed therein. The openings 24 can be disposed in any area of the primary compartment 18 such that a desired amount of air can be pumped into and through the vessel 12, except they can be located high enough above the vessel floor so they are above any liquid that collects there. The composting system 11 can include a pump 26 (or blower) that is connected to the openings 24 via tubing 28 to direct the air from the pump 26 into the vessel 12. If the primary compartment 18 has multiple openings 24, the composting system 11 can include a manifold 30 to distribute the air from the pump 26 to multiple pieces of tubing 28 to deliver the air to each opening 24. An upper part of the primary compartment 18 or lid 16 can include an air outlet 32 for discharge of air. The outlet 32 can feed the air forced into and through the vessel 12 to a filter 34 to reduce the odors present in the vessel 12 before the air is released. If there are a series of vessels 12 each one could have its own filter 34, or each outlet 32 could be connected by a manifold to a single exhaust outlet and a single series of filters could be disposed in the exhaust outlet. In one embodiment, the series of filters are particulate, biologic, and carbon filters.

The vessel 12 could also have a shell 36 covering a portion of the vessel 12. The shell 36 could be decorative and hide the functional elements of the vessel 12 such as the hinges and air inlets. This innovation has two primary purposes. The first purpose of the shell 36 is to spiritually elevate the vessel 12 from its utilitarian purpose to one that is suitable for sacred ritual. The shell 36 allows families to say a final farewell to a beloved in an emotionally uplifting way. Simply by placing the vessel 12 in a beautiful shell, the ritual becomes akin to an in-the-ground burial rather than an industrial process which can provide much-needed comfort to a bereaved family. The second purpose of the shell 36 is the facilitation of laying-in ceremonies at places where we expect rituals to occur, such as churches or funeral home chapels. The shells 36 can remain at these locations while the vessels 12, which are relatively easy to transport, are brought to the shells 36 for ceremonial laying-in of the body. After the ritual, the vessel 12 is returned to the facility that will oversee the composting process. The shell 36 can be left behind for re-use. The shells 36 can be used either indoors or in an outdoor setting.

At the completion of the composting process, there is an opportunity for a ceremony that celebrates the return of the human remains to the Earth from which it came. This ritual can occur in a wide range of locations, which again puts an emphasis on the portability of the shells if they are to be used in the laying-out ritual. The ritual can use all the compost or just a token amount or none at all. It is frequently accompanied by a tree planting ceremony, or spreading of seeds, using the regenerative soil as the compost.

Either the vessel 12 or the shell 36 could also include wheels 38 attached thereto to permit movement of the vessel 12. The vessel 12 or the shell 36 could also be secured into a chassis with a big wheel 38 on each side thereof that permits the vessel 12 to be rotated about a horizontal line, which essentially stirs up the contents in the vessel 12 and contributes to the composting process, and rotated about a vertical line, which essentially permits the vessel 12 to be maneuvered to a desired location and position. The shell 36 can also have arced plates 40 attached thereto to support various parts of the shell as the shell 36 is rotated. The wheels 38 can be rotatably attached or securely attached to the vessel 12 or the shell 36. When the wheels 38 are securely attached it allows the contents of the vessel 12 to be stirred and mixed by rolling the vessel 12. This permits the operator to agitate the contents without the need to open the vessel 12 while the composting may still be in process. In one embodiment, the wheels 38 can be selectively locked so that the vessel 12 can be rolled over when the wheels 38 are locked and the vessel 12 can be moved without rolling when the wheels 38 are unlocked.

From the above description, it is clear that the present disclosure is well-adapted to carry out the objectives and to attain the advantages mentioned herein as well as those inherent in the disclosure. While presently preferred embodiments have been described herein, it will be understood that numerous changes and combinations may be made which will readily suggest themselves to those skilled in the art and which are accomplished within the spirit of the disclosure and claims.

What is claimed is:

1. A method of composting human remains to produce a composting material, the method comprising:
placing human remains in a vessel;
placing a bulking agent mixture with the human remains in the vessel; and
placing a compost solution in the vessel to accelerate the composting of the human remains.

2. The method of claim 1 wherein the bulking agent mixture comprises straw, wood chips, earthworm castings, and corn cobs or spent hops.

3. The method of claim 2 wherein the straw is present in the bulking agent mixture in a range of about 30 lbs to about 50 lbs per 100 lbs of human remains, the wood chips is present in the bulking agent mixture in a range of about 50 lbs to about 70 lbs per 100 lbs of human remains, and the earthworm castings is present in the bulking agent mixture in a range of about 20 lbs to about 40 lbs per 100 lbs of human remains.

4. The method of claim 2 wherein the corn cobs or spent hops is present in the bulking agent mixture in a range of about 20 lbs to about 40 lbs per 100 lbs of human remains.

5. The method of claim 1 wherein the compost solution includes biologically active fungi and bacteria that has aerated in oxygenated water for at least 48 hours.

6. The method of claim 1 further comprising sealing the vessel with the human remains, the bulking agent mixture and the compost solution therein.

7. The method of claim 1 further comprising permitting the temperature in the vessel to raise above 131 degrees Fahrenheit for more than 72 hours.

8. The method of claim 1 wherein the composting method is carried out for more than 90 days.

9. The method of claim 1 further comprising mixing the human remains, the compost solution and the bulking agent mixture after the human remains have composted for a desired amount of time.

10. The method of claim 1 further comprising the step of applying a biochar mixture to the vessel to decompose bones.

11. The method of claim 1 further comprising pumping air across the human remains, the compost solution and the bulking agent mixture.

12. A system used in a process for composting human remains, the system comprising:
a vessel for receiving the human remains, a bulking agent mixture, and a compost solution;
at least one opening in a lower part of the vessel for receiving a stream of air;
a lid for closing the human remains, the bulking agent mixture, and the compost solution in the vessel; and
an outlet disposed in the vessel to permit the air from the at least one opening and unpleasant odors created in the vessel to be withdrawn from the vessel.

13. The system of claim 12 further comprising a pump to force air through the at least one opening in the vessel.

14. The system of claim 13 further comprising tubing that connects the pump to the at least one opening in the vessel.

15. The system of claim 12 wherein the outlet includes a charcoal filter disposed therein to retard the unpleasant odors in the vessel.

16. The system of claim 12 wherein the vessel and lid includes a nonpermeable membrane disposed on inside portions thereof, respectively, to prevent material in the vessel from leaking.

17. The system of claim 12 further comprising a sealing member disposed between the lid and the vessel.

18. The system of claim 12 further comprising a decorative shell the vessel can be placed into.

19. The system of claim 18 further comprising a selectively lockable wheel disposed on each side of the vessel or the decorative shell to be able to rotate the vessel or shell around a horizontal line and mix the human remains, the bulking agent mixture, and the compost solution or to move the vessel or shell to a desired location.

20. The system of claim 16 further comprising a tube that connects the at least one opening in the vessel to a corresponding opening in the nonpermeable membrane.
